(19) United States
(12) Patent Application Publication
(10) Pub. No.: US 2009/0319424 A1
(43) Pub. Date: Dec. 24, 2009

(54) POSTAL MAIL DEPOSIT AGENCY

(75) Inventors: Matthew A. Calman, Charlotte, NC (US); Doug Dejong, Huntersville, NC (US); Todd Inskeep, Charlotte, NC (US); Garrett C. Briggs, Seattle, WA (US); Marie LaQuerre, Matthews, NC (US); Kevin Benton, Mathews, NC (US); Mark Zanzot, Huntersville, NC (US); Robert L. Kee, Charlotte, NC (US); David T. Frew, Fort Mill, SC (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/264,978

(22) Filed: Nov. 5, 2008

Related U.S. Application Data
(60) Provisional application No. 61/074,217, filed on Jun. 20, 2008.

(51) Int. Cl. G06Q 40/00

(52) U.S. Cl. 705/42; 705/35; 705/45

(57) ABSTRACT

Apparatus and methods for electronically depositing a check in a bank account. In some embodiments, the apparatus and methods may involve a check identification module configured to analyze content of an electronically imaged postal mail item; and a customer control module configured to receive from a customer an instruction to deposit the check in the bank account.

### CROSS-REFERENCE TO RELATED APPLICATION

This is a non-provisional application of U.S. Provisional Application No. 61/074,217, filed on Jun. 20, 2008, which is hereby incorporated herein in its entirety.

### FIELD OF TECHNOLOGY

Aspects of the disclosure relate to the use of an electronic communication network to deposit a check.

### BACKGROUND

A postal mail image service acts as a receiving agent for its customers, which are recipients of postal mail. Such a service receives physical mail on behalf of the customers and provides the customers with electronic access to images of the customers' mail items. Postal mail image services allow users to receive, scan, and effect disposition of mail, but they cannot process checks received by their customers. Between 1% and 3% of the mail handled by such services contains checks. The checks must then be forwarded to the customers for deposit. This increases time and reduces the advantage of image-based mail processing.

### SUMMARY OF THE INVENTION

Apparatus and methods for electronically depositing a check in a bank account are provided. In some embodiments, the apparatus and methods may involve a check identification module configured to analyze content of an electronic mail item and a customer control module configured to receive from a customer an instruction to deposit the check in the bank account.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a schematic diagram of apparatus that may be used in connection with the principles of the invention;

FIG. 2 shows an illustrative system in accordance with the principles of the invention;

FIG. 3 shows an illustrative process in accordance with the principles of the invention;

FIGS. 4A and 4B show another illustrative process in accordance with the principles of the invention;

FIG. 5 shows illustrative processes in accordance with the principles of the invention;

FIGS. 6A and 6B show details of an illustrative process shown in FIG. 5;

FIG. 7 shows details of another illustrative process shown in FIG. 5; and

FIG. 8 shows details of yet another illustrative process shown in FIG. 5.

### DETAILED DESCRIPTION OF THE INVENTION

Apparatus and methods for secure and robust deposit and payment processing for image postal mail are provided. The apparatus and methods may consolidate mail reading, bill payment and deposit processing. Check presentation and/or deposit may be made during mail processing by an image postal mail service. This may avoid the need for transporting the check to a financial institution after the check is received by the image postal mail service. A customer of the image postal mail service may be charged a fee for depositing or presenting the check. In some embodiments, the customer may be provided with one or more options regarding how the check will be deposited.

In some embodiments, the customer may issue a standing instruction that all checks received are to be deposited in a bank account selected by the customer. This may avoid the need for the customer to browse through image mail, identify checks to be deposited, and issue instructions for their deposit.

The apparatus and methods may involve one or more of at least three methods for depositing checks. Checks may be deposited using any suitable approach. For example, deposits may be processed using deposit-image ATMs, image exchange processes, and Automated Clearinghouse (“ACH”) check conversion.

The apparatus and methods may include extension services. The extension services may include lockbox-like services to aid customers who are interested in processing invoice payments or other transactions through the postal mail image service provider. The lockbox-like services may provide for the secure transmission of customer-related information regarding payments to a payee. The customer-related information may support the integration of accounts receivable processes with the apparatus and methods of the invention.

Security of customers' bank account numbers in storage may be provided by storing a common customer identifier that may be substituted, during transaction processing, by the bank or a trusted or disinterested entity.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

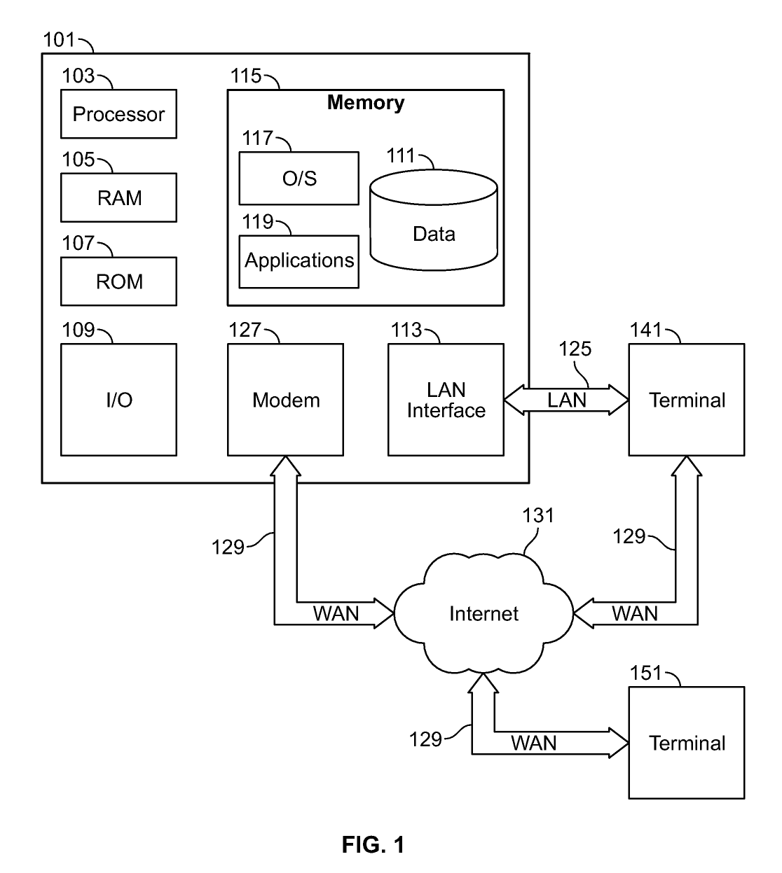

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 201 computer executable instructions may be embodied in hardware or firmware (not shown). As described in detail below, database 121 may provide storage for images, customer account information, customer information and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by an individual to open, view and process mail and to issue one or more instructions regarding the deposit of a check into a bank account. Customer attribute information, including bank account information, may be stored in memory 125. The attribute information may be processed by an application such as one of applications 119.

One or more of applications 119 may include an algorithm that may be used to detect a check via image analysis or magnetic ink character recognition (“MICR”).

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

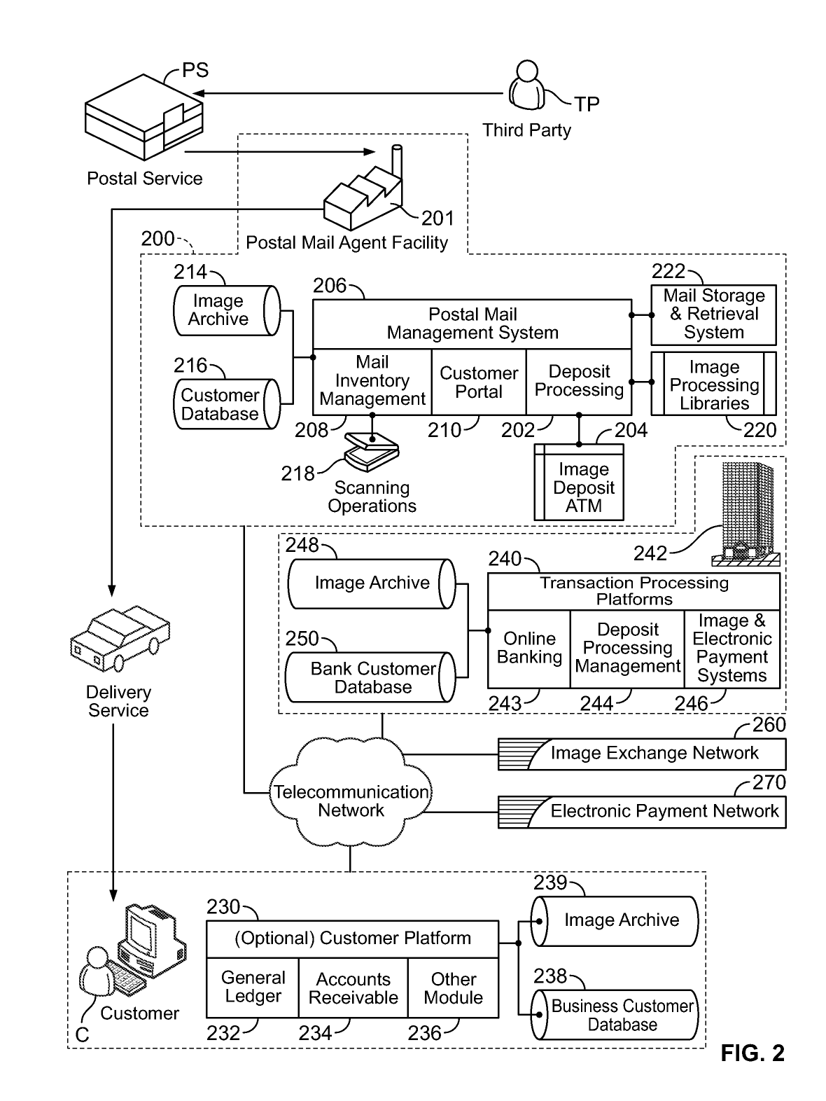

FIG. 2 shows illustrative system 200 for processing deposits in the context of postal mail image services. For the sake of illustration, an entity that receives and deposits a check via the services of a postal mail agent will be referred to as the “customer” of the postal mail agent. The postal mail agent may act as an agent of the customer for the receipt of postal mail from any mail distributor, such as the U.S. Postal Service, a private courier or any other mail distributor. An individual or entity that sends the customer a check will be referred to as the “third party.”

FIG. 2 shows that third party TP transmits to postal service PS a mail item. Postal service PS transmits the mail item to postal mail agent facility 201 in system 200. System 200 may include postal mail management system 206. Postal mail management system 206 may include mail inventory management module 208, customer portal 210, and deposit processing module 202 and any other suitable modules.

Postal mail management system 206 may be linked to image archive 214 and postal mail agent customer database 216. The mail item may be scanned by scanning operations 218. An image corresponding to the item may be processed by mail inventory management module 208. Mail inventory management module 208 may store a copy of the image in image archive 214. Customer identification records may be stored in customer database 216. Each image in image archive 214 may be cross-referenced to a customer identification record in customer database 216. The cross-reference may include a pointer, a hyperlink or any other suitable data structure or object.

Postal mail management system 206 may interact with mail storage and retrieval system 222. Mail storage and retrieval system 222 may include facilities for indexing, storing and retrieving physical mail items before or after the mail items are scanned by scanning operations 218.

Customer C may direct processes involving images in image archive 214. Customer C may direct the processes by interacting with customer portal 210. Customer portal 210 may provide customer C with electronic tools for processing images in image archive 214. The processing may include viewing, saving, marking, attaching, forwarding, deleting, depositing and any other suitable acts.

Customer portal 210 may provide customer C with electronic tools for establishing rules for processing mail items that are received by system 200. The rules may relate to the forwarding, scanning or disposition of physical mail items. The rules may relate to the processing of mail item contents. Mail item contents may include personal communications, bills, checks, advertisement and other mail content.

Customer C may use customer portal 210 to deposit a check from image archive 214. Customer portal 210 may instruct deposit processing module 202 to take action on a check image stored in image archive. Deposit processing module 202 may be linked to image processing libraries 220. Image processing libraries 220 may include one or more algorithms for identifying transactional and identification information that may be present in an image of a check. In some embodiments, the algorithms may support the accurate and secure deposit of the check.

Deposit processing module 202 may be configured to deposit the check in one of several different manners. For example, deposit processing module 202 may execute processes to direct an automated transaction machine (“ATM”) deposit by personnel in postal mail agency facility 201. ATM deposits may be made using image deposit ATM 204. Image deposit ATM 204 may be in electronic communication with deposit processing module 202. Deposit processing module 202 may execute an image-based deposit. Deposit processing module 202 may execute an electronic deposit.

Customer C may be an individual or a business entity. Customer C may be a subscriber to the services of system 200. Customer C may receive checks via postal mail agency 201. Customer C may deposit the checks in a bank account using customer portal 210. Customer C may require the depositing of a large volume of checks. Customer C may maintain a customer accounting platform such as customer platform 230. Customer platform 230 may include general ledger module 232, accounts receivable module 234 and one or more other suitable business or accounting modules such as other module 236.

When the business entity deposits a check using customer portal 210, postal mail management system 206 may provide accounts receivable module 234 with information required to credit the proper account. Account identification records may be stored in business customer database 238. Accounts receivable information for accounts receivable module 234 may be stored in business customer database 238. Image archive 239 may receive images of checks from postal mail management system 206 and other suitable documents that correspond to the identification and/or accounts receivable information in business customer database 238. System 200 may be configured to provide batch check processing for the business entity through customer portal 210 or a separate application. System 200 may provide accounts receivable module 234 with batch updates based on the batch check processing. System 200 may provide updates in sub-batches or in a single-transaction flow.

When system 200 deposits a check, it may interact with a transaction engine of a banking institution. For example, system 200 may interact with transaction processing platforms 240 at bank 242. Bank 242 may be referred to as a “depository bank.” Transaction processing platforms 240 may include online banking platform 243, deposit processing management platform 244, image and electronic payment systems platform 246 and any other suitable platforms. Transaction processing platforms 239 may be in communication with image archive 248 and bank customer database 250.

When system 200 deposits a check via deposit processing module 202, deposit processing module 202 may transmit an image of the check to deposit processing management platform 244. Deposit processing management platform 244 may determine which bank the deposited check is drawn on. Checks drawn on bank 242 (“on-us checks”) would be processed in accordance with prevailing check payment processes at bank 242. Bank 242 may process on-us checks in an image process. Bank 242 may process on-us checks in a paper process with image replacement documents (“IRDs”). Bank 242 may use other approaches, whether electronic, mechanical or both, to process on-us checks. Checks drawn on banks other than bank 242 (“transit checks”) may be sent for payment (“presented”) by deposit processing management platform 244. Transit checks may be sent through image exchange network 260 for presentment. The presentment may be in accordance to with suitable laws, rules and/or standards. Transit checks may be sent through electronic payment network 260 for presentment. The presentment may be in accordance with suitable laws, rules and standards. Transit checks may be converted to image replacement documents (“IRDs”) and processed through traditional paper check processing, presentment and clearing processes (not shown). One of ordinary skill in the art will appreciate that the extensive processes and sub-processes that may be involved in industry standard check processing are not necessarily illustrated here.

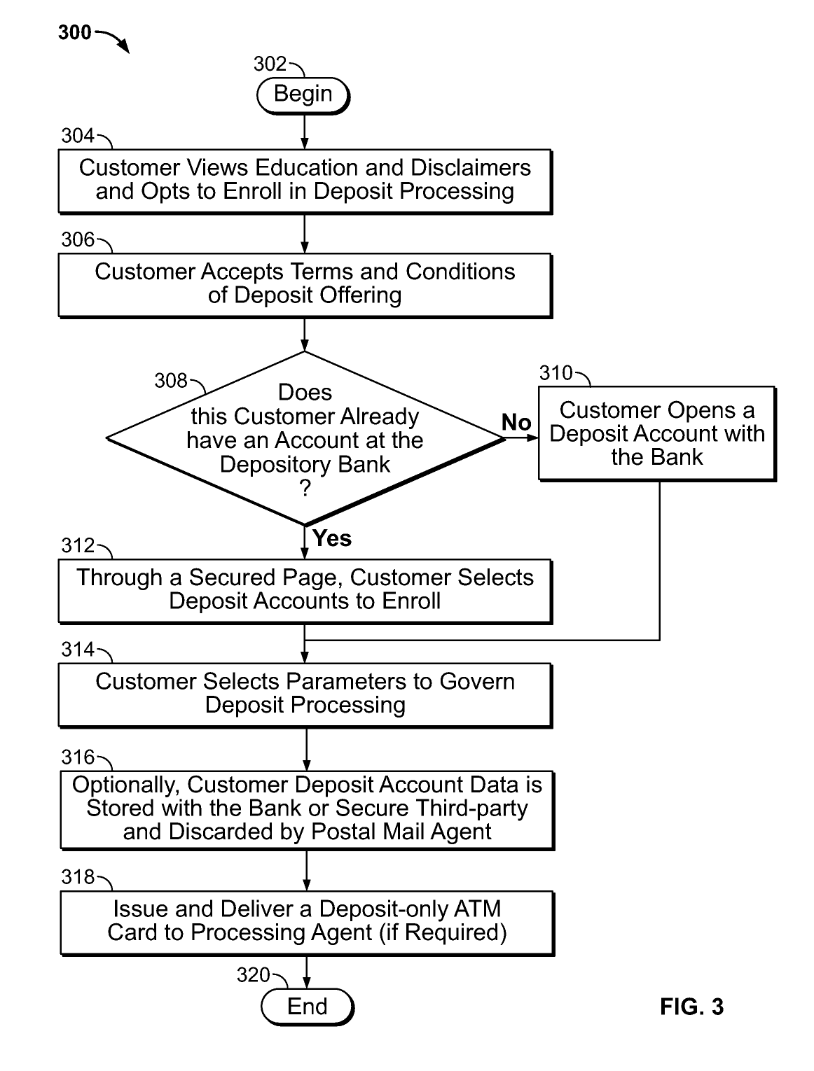

Processes in accordance with the principles of the invention may include one or more features of the processes illustrated in FIGS. 3-8. For the sake of illustration, the processes illustrated in FIGS. 3-8 will be described as being performed by a “service”. The “service” may involve one or more of the devices shown in FIG. 1, one or more of the devices, systems or entities shown in FIG. 2, one or more individuals and/or any other suitable device or approach. The “service” may be provided by an entity. The entity may be an individual, an organization or any other suitable entity.

FIG. 3 shows illustrative process 300 for enrolling a customer such as C (shown in FIG. 2) in a postal mail agency deposit program. Deposit enrollment may encompass the education and enrollment of customers in a deposit and/or payment processing service. If a customer does not already have a deposit account with a depository bank that is affiliated with the program, the customer may be required to open such an account. The account may be opened using a streamlined opening process. A customer with existing bank accounts at an affiliated depository bank may be connected to a website where the customer can select which of the account(s) are to be eligible for the service.

Parameters governing the processing of the customer's deposit/payment account may be selected. The parameters may include reporting mechanisms, level of detail in the reporting, reject processing rules, etc. If the customer elects image ATM deposits, a deposit-only ATM card may be authorized by the customer and issued to the postal mail agent for secure storage and subsequent use.

Process 300 may begin at step 302. At step 304, the customer may view educational information and disclaimers. The customer may then opt to enroll in the postal mail agency deposit program. At step 306, the customer may accept terms and conditions of the program. At step 308, the service may determine whether the customer already has an account at the depository bank, such as bank 242 (shown in FIG. 2).

If the customer does not already have such an account, process 300 may continue at step 310. At step 310, the customer may open a deposit account with the bank. Step 310 may include customized account-opening steps for postal mail agent customers. Step 310 may take place in a bank branch office. Step 310 may take place in an online transaction. Process 300 may proceed at step 314.

If the customer does have a deposit account at the depository bank, process 300 may continue at step 312. At step 312, the service may provide the customer with a secured web page. Using the secured web page, the customer may identify, select or otherwise designate the customer's existing account or accounts at the depository bank. For example, the customer may be directed to a specialized secure bank website. The customer may use the website to log on to the customer's online banking platform such as online banking platform 243 (shown in FIG. 2). Using the online banking platform, the customer may select the account from a list.

The service may then link the existing account to (or otherwise associate the existing account with) the customer's records in a postal mail management system such as 206. After step 312, process 300 may continue at step 314.

At step 314, the customer may select rules that are to govern deposit processing for the checks that system 200 will receive on behalf of the customer. The rules may include: “always deposit checks to a specific account,” “always deliver ineligible or rejected checks to the customer,” reporting mechanisms, types of reporting, additional processing options, such as data or image delivery of companion documents, and any other suitable rules.

Process 300 may continue at step 316. At step 316, the customer optionally may store the designated depository account information in memory controlled by the depository bank or a secured third party. The designated depository account information may be erased from system 200 storage devices. A step such as 316 may be used to reduce risk for the operator of system 200. The depository bank or the secured third party may insert or substitute bank account numbers for other mutually-understood customer identifiers into secured transaction processes as appropriate.

Process 300 may continue at step 318. At step 318, the service may issue and deliver a deposit-only ATM card to a processing agent. The processing agent may be an individual that may use the card to execute ATM deposits of checks in connection with instructions from a deposit processing module such as 202.

Process 318 may end at step 320.

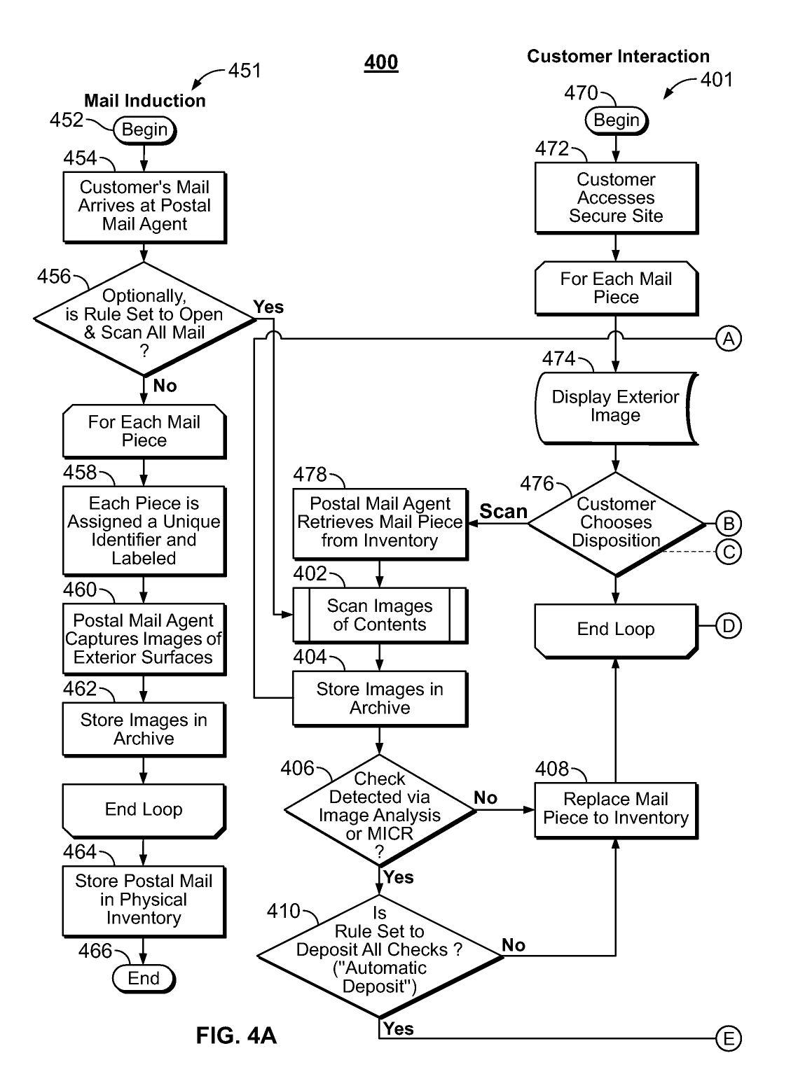

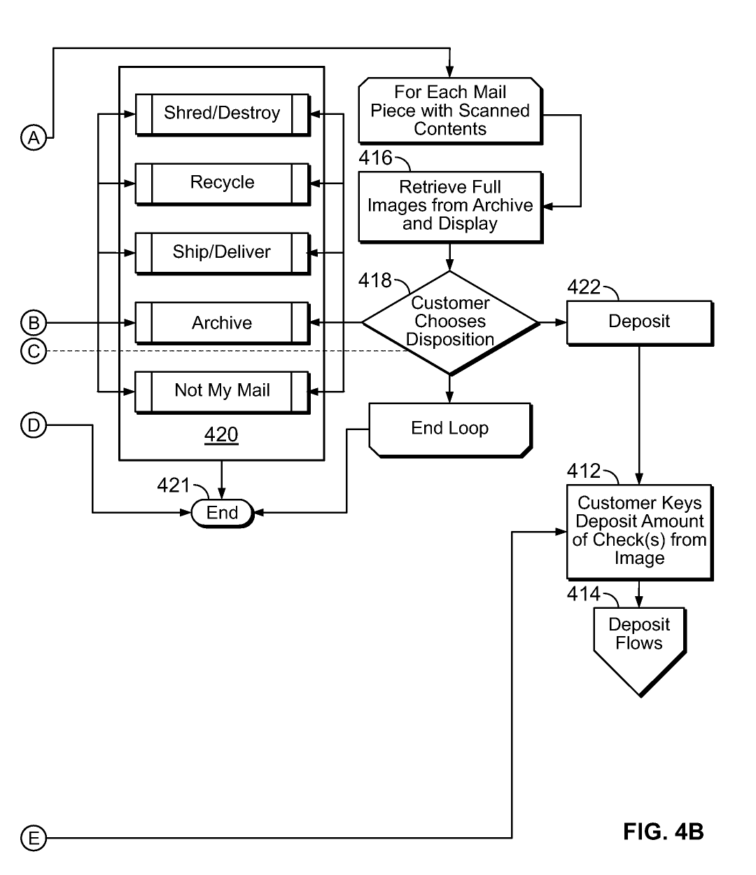

FIGS. 4A and 4B show illustrative process 400 for induction and customer interaction. Process 400 may include illustrative mail induction sub-process 451 and illustrative customer interaction sub-process 401. In illustrative mail induction sub-process 451, the service may prepare mail items addressed to a customer such as C (shown in FIG. 2) for viewing and further processing under the direction of the customer. In customer interaction sub-process 401, the customer may view, respond to, discard and otherwise dispose of the mail items and, in some embodiments, corresponding images.

Induction and customer interaction processes may encompass, among other things, adding or removing a customer interaction for deposit processing. For example, a customer may select a step in which the customer may keyboard the amount of each check they wish to deposit. Such a step may be used to control risk for certain customers or transactions.

Mail induction sub-process 451 may begin at step 452. At step 454, the customer's mail items may arrive at a postal mail agent. For example, the mail items may arrive at a facility such as 201 (shown in FIG. 2). At step 456, the service may determine whether the customer has selected a rule requesting that all mail should be opened and the contents scanned. If the service determines that such a rule was selected, process 400 may shift from mail induction sub-process 451 to customer interaction sub-process 401. If such a shift occurs, process 400 may continue at step 402.

At step 402, mail item contents may be scanned. Process 400 may continue at step 404. At step 404, one or more images of the mail item and/or its contents may be archived. At step 406, a check that is present in the mail items may be identified using any suitable method, such as image analysis or MICR (“magnetic ink character recognition”) detection, through optical or magnetic properties.

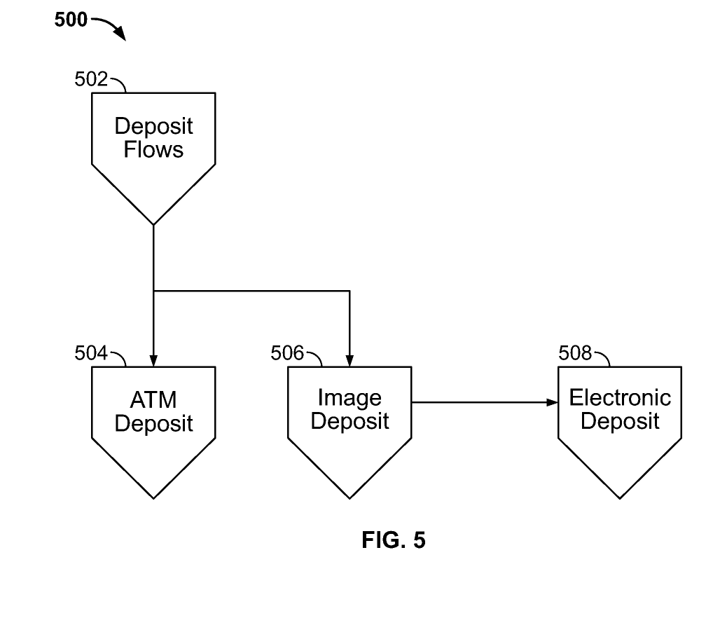

If at step 406 a check is not detected, the mail item may be returned to inventory at step 408. If a check is detected, process 400 may continue at step 410. At step 410, a processor may determine whether the customer has selected a rule requiring that all checks be deposited into a bank account. If such a rule has not been selected, the check may be returned to inventory at step 408. If such a rule has been selected, process 400 may continue at step 412. At step 412, the customer may key in a deposit amount corresponding to the amount shown on the check. In some embodiments step 412 may be bypassed by the customer. In some embodiments, step 412 may be performed by the agent, by human operator, computer algorithm, or other means. At step 414, process 400 may then transfer control to other processes that govern deposit flow. Examples of such processes are shown in FIG. 5.

In some embodiments, after storage of images at step 404, a processor may, at step 416, retrieve from archive, and display, images of the mail item contents (the “full” images, as set forth in FIG. 4B at step 416). This provides the customer with an opportunity to view images of the contents of the mail item. In some embodiments, step 416 may be performed at the discretion of the customer.

At step 418, the customer may choose a disposition for the mail item contents. Dispositions 420 include shred/destroy, recycle, ship/deliver, archive and “not my mail.” After step 420, process 400 may end at step 421.

If the item is a check, the check may be deposited at step 422. In some embodiments, step 422 may be made available to the customer only if the scanned contents of the mail item includes include a check. The item may be identified as a check during step 406 after the customer selects Scan as the disposition in steps 476 or 418. Process 400 may proceed from step 422 to step 412, which is described above.

If at step 456 of sub-process 451 the service determines that the customer has not selected a rule requesting that all mail items be opened and scanned, sub-process 451 may continue at step 458. At step 458, the mail item may be assigned a unique identifier and may be labeled. At step 460, the service may capture images of exterior surfaces of the mail item. At step 462, the service may store the images of the external surfaces in an archive such as image archive 214 (shown in FIG. 2). At step 464, the service may store the mail item in a physical inventory such as mail storage and retrieval system 222 (shown in FIG. 2). The mail item may be stored in the physical inventory in such a way that the customer can request recall of one or more mail items for scanning, viewing and disposition. Sub-process 451 may terminate at step 466.

Customer interaction sub-process 401 may include, in part, steps that a customer may take after a mail item has been processed, or partially processed, by mail induction sub-process 451. Customer interaction sub-process 401 may begin at step 470.

At step 472, the customer may electronically access a secure web site. The secure web site may be part of a customer portal such as 210 (shown in FIG. 2). The secure website may be integrated into another application, such as an email application or financial application. The customer may interact with the postal mail service in an intermingled fashion with email in an integrated application. At step 474, the service or application may display an exterior image of the mail item. At step 476, the customer may choose a disposition of the mail item. If the customer chooses to scan contents of the mail item, sub-process 451 may continue at step 478. At step 478, the service may retrieve the requested mail item from a physical inventory such as mail storage and retrieval system 222 (shown in FIG. 2). The mail item may be scanned at step 402. Sub-process 401 may continue at step 404 as described above.

In some embodiments, the service may notify the customer that a check is present in a mail item. The notification may take place, for example, at step 474. The customer may elect to view and deposit the check. To deposit the check from step 476, the customer may elect to bridge over to step 418, which is described above. From step 418, the customer may move to step 422 to deposit the check as described above.

At step 476, the customer may choose one or more of dispositions 420 for the mail item. Dispositions 420 were described above in connection with images of mail item contents retrieved from archives at step 416. Analogous dispositions are provided at step 420 for unopened mail items. In some embodiments, the customer may choose, at step 476, to apply one or more of dispositions 420 to the image of the mail item. In some embodiments, the customer may choose to apply one or more of dispositions 420 to the mail item itself.

FIG. 5 shows illustrative process 500 that may bridge between a customer instruction to deposit a check and a check deposit flow. For example, step 502 may correspond to deposit flows 414 (shown in FIG. 4B). From step 502, process 500 may continue to one of several illustrative deposit channels: ATM deposit 504, check image deposit 506, or electronic deposit 508. In some embodiments the service may select one of the channels for depositing the check. In some embodiments, the customer may select one of the channels for depositing the check. In some embodiments, the customer may select a rule which governs the channel for depositing the check, based upon the maker (“payer”) of the check, the amount of the check, or other business-related choices.

In ATM deposit 504, a standard deposit-image ATM may be deployed in connection with a system such as 200 (shown in FIG. 2). In particular, the deposit-image ATM may be deployed in connection with scanning operations 218 (shown in FIG. 2). The customer may request a special “deposit-only” ATM card, whereby the only transaction accessible with the card is a deposit function. The request for the issuance of such an ATM card may be made as part of an enrollment process such as process 300 (shown in FIG. 3).

The ATM card may have a common or standard personal identification number (“PIN”), such as “1234.” The ATM may have a customer-assigned PIN. The ATM card may be stored at the scanning operation site. The ATM card may be subject to physical access control, dual control, or other control methods to restrict access by unauthorized persons. The card may be retrieved by the service when a deposit is requested. Using the card and the PIN, the service may deposit the check using the ATM. The ATM may provide a printed receipt. The service may scan the printed receipt and electronically provide an image of the printed receipt to the customer for reference and proof of deposit. The service may place the deposit slip in the envelope from which the deposited check was removed for deposit and return the envelop to inventory.

In some embodiments, ATM deposit process 504 may encompass the placement of one or more standard deposit-image ATMs in the postal mail image service facility. Representatives of the service would follow a process that may include one of more of: retrieving checks to be deposited, verifying them, endorsing them, tallying them into a daily deposit, retrieving the customer's deposit-only ATM card, processing the deposit, imaging the receipts, notifying the customer and returning the receipt, mail and ATM card to inventory. Items rejected by the ATM for processing could be forwarded to the customer or optionally returned to the sender (such as third person party TP (shown in FIG. 2)) with a customer-specific insert.

In an image deposit process 506, a postal mail management system such as 206 (shown in FIG. 2) may be integrated with the image deposit platform of a bank, such as bank 242 (shown in FIG. 2). The image deposit platform may be configured for straight-through image processing. Customer check images may be used for deposit and check clearing without rehandling or reimaging the corresponding paper check. Images of documents that are present in a mail item (e.g., an envelope) may also be processed. The images of the documents may be packaged and delivered to the customer in the form of an image-lockbox service. The image lock-box service may provide the customer with the images of the documents along with images of other information, including one or more checks. The image lockbox service may interpret images of documents to provide transactional data to the customer. This data may include customer number, invoice number, amount of invoice, and other information.

In some embodiments, image deposit process 506 may encompass high-volume processing. Image deposit process 506 may integrate image and/or electronic payment networks. In such a process, transactions may be collected for transmission to the bank, for electronic deposit, en masse. Amount recognition technology may be employed in lieu of customer keying. Image quality analysis may be performed prior to submission, so that any failed items can be forwarded to the customer for processing as a paper deposit, or optionally handled in other ways, as with the ATM flow. This flow incorporates a feature where the customer's account number is not stored with the agent, but is substituted for a mutually-known customer identifier by the bank when the file is received, to aid in fraud prevention. Image-lockbox extension features may be included here, where customers could receive images of payment documents or interpreted data from companion documents in the envelope with the check payment.

In electronic deposit process 508, a check deposit may be converted into an ACH transaction. The service may audit the customer and the check to determine whether regulatory requirements for the ACH transaction are satisfied. The regulatory requirements may relate to payment eligibility, payor pre-notification and the like.

In some embodiments, electronic deposit process 508 may extend from an image deposit flow such as 506 for those checks eligible for conversion to ACH transactions. Customer preferences and regulatory requirements, such as payor type and pre-notification, may determine whether or not checks are eligible. This flow is substantially similar to the image flow, however the clearing network may involve ACH instead of check image exchange.

Each of processes 504, 506 and 508 may involve one or more of deposit-image ATMs, transaction concentrators, transaction networks, transaction processing platforms, data perfection platforms, quality testing platforms, electronic transaction portals, and industry-accepted protocols, formats, and processes to effect the transaction. The processes may involve postal mail image, tunneled account opening process during enrollment, integration with email applications, integration with financial applications, use of deposit-only ATM cards in the consumer segment, picklist retrieval and deposit batching processes, imaging of ATM receipts and delivery back to customers, and image lockbox-like functions, which may be appropriate for small businesses.

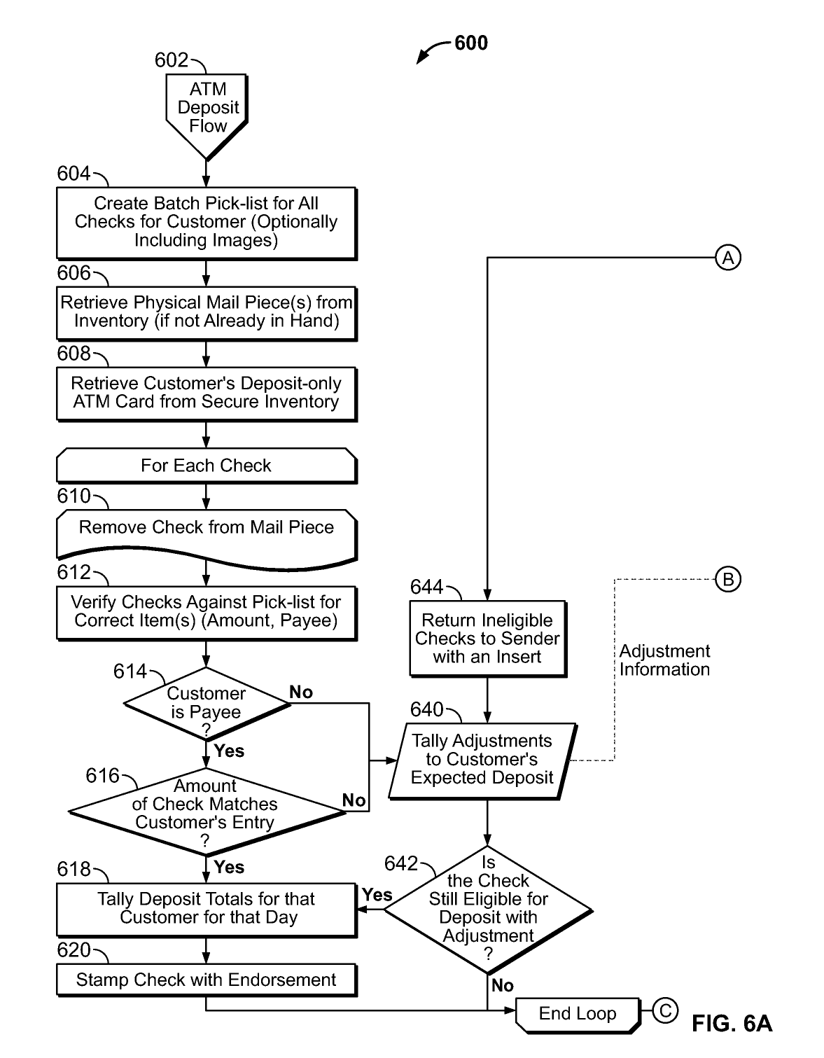

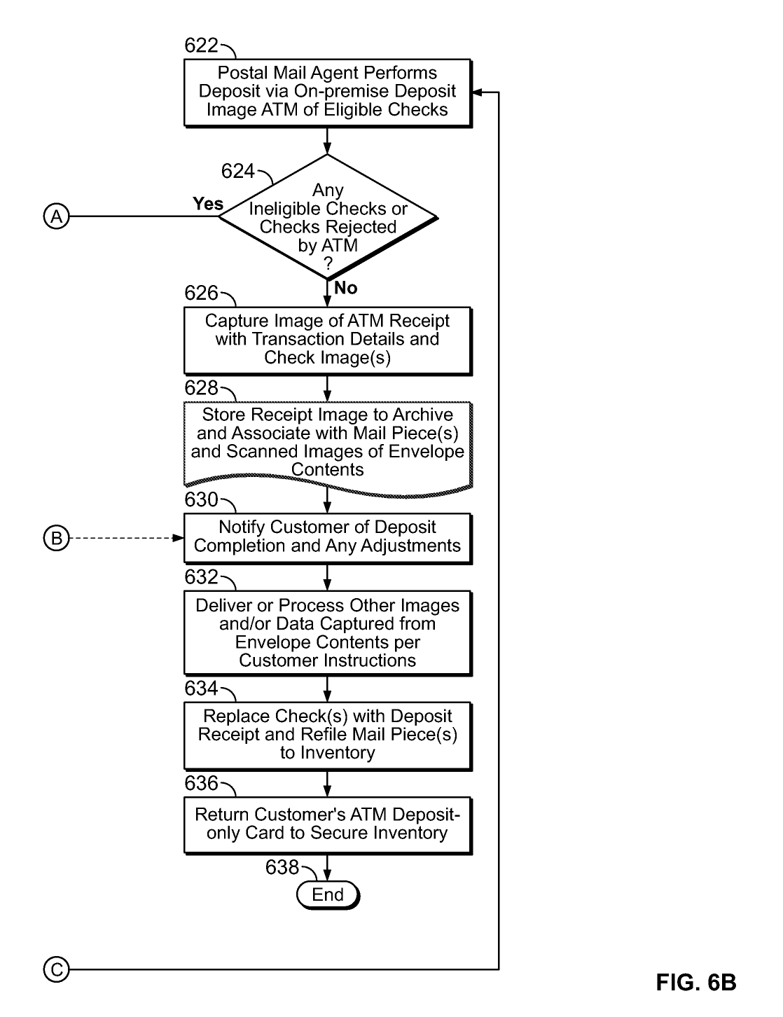

FIGS. 6, 7 and 8 further illustrate processes 504, 506 and 508 (shown in FIG. 5).

FIGS. 6A and 6B show illustrative ATM deposit process 600. Process 600 may begin at step 602. Step 602 may correspond to step 504 (shown in FIG. 5). Process 600 may continue at step 604. At step 604, the service may create one or more batch picklists of checks received on behalf of the customer. The picklist may be printed hardcopy. The picklist may be electronically loaded to a handheld computer for an operator to carry through the inventory storage location. The picklist may be electronically transmitted to an automated inventory storage/retrieval automation system. The service may display images of the checks along with, or in place of, the picklists. In some embodiments, check retrieval may be performed in batch mode to reduce inventory transactions. In some embodiments, a batch may include checks from a single customer. In some embodiments, a batch may include checks from more than one customer. At step 606, the service may retrieve physical mail items from inventory. At step 608, the service may retrieve the customer's deposit-only ATM card from a secure inventory. In some embodiments, step 608 may include control procedures in order to prevent unauthorized access to the customer's deposit-only ATM card. Step 608 may be accomplished by manual or automated means. Step 608 could employ multi-use cards, whereby a blank card is encoded with the customer-specific identification data to enable its use in subsequent steps, then later erased and reused for another customer.

Steps 610, 612, 614, 616, 618 and 620 may be executed in connection with one check or with each of numerous checks.

At step 610, one or more checks may be removed from corresponding mail items. At step 612, the service may verify the one or more checks against picklist results received from the customer. The verification may compare item information, check amounts, payee identification and other information from the checks to the picklists. At step 614, the service may verify that the customer is identified as the payee on the one or more checks. (When a customer account is a joint account, a business account for a business that uses multiple names or a sole proprietorship for which checks can be made to the business or the individual, or the like, the customer may identify more than one eligible payee name that is acceptable for the account.)

Verifications and comparisons in steps 612 and 614 may be manual or may be automated.

If the customer is identified as the payee, process 600 may continue at step 616. At step 616, the service may determine whether the amount of the check matches a customer amount entry may be verified. The customer amount entry may be an entry made in connection with step 412 (shown in FIG. 4B). If the amount of the check matches the customer amount entry, process 600 may continue at step 618. At step 618, the service may tally deposit totals for the customer (for a day, e.g.). At step 620, the service may stamp the check with an endorsement on behalf of the customer.

At step 622, the service may deposit eligible checks using a deposit image ATM. Upon acceptance by the deposit image ATM, the checks may be retained within the locked chassis of the ATM. At the conclusion of step 622, the deposit image ATM may print receipt which may contain images of the checks deposited. At step 624, the service may determine whether the deposit image ATM rejected any of the checks. For the checks that were not rejected, process 600 may continue at step 626. At step 626, the service may capture an image of a deposit receipt from the deposit image ATM. The receipt may show details of the deposit transaction. The deposit receipt image may be “attached” (logically associated in customer interactions) to an image of the check. At step 628, the service may store the deposit receipt image in an archive such as archive 214 (shown in FIG. 2). The service may cross-reference the deposit receipt image with the mail item to which it corresponds and with images of any other suitable contents or features of the mail item. The service may store the physical receipt in the mail envelope which carried the deposited check(s).

Using a customer portal such as 210 (shown in FIG. 2), the customer may retrieve images of the mail item contents. In some embodiments, the check image may be replaced or accompanied by the deposit receipt image. The customer may retrieve images of other contents associated with the mail item. For example, the customer may retrieve an invoice image that corresponds to the invoice that was paid by transmission and deposit of the check.

At step 630, the service may notify the customer of deposit completion. The service may notify the customer if any adjustments relative to the check amounts or the customer's amount entry were made. The customer's amount entry may be an entry made in connection with a step such as 412 (shown in FIG. 4B). Notification may be made through the service's secure website. The customer may access the secure web site, for example, through a customer portal such as 210 (shown in FIG. 2). In some embodiments, the service may notify the customer about the deposit using email, text messaging or any other suitable method of notification selected and specified during customer enrollment step 314.

At step 632, the service may deliver or process other, e.g., non-check, images corresponding to mail item contents. The processing of the other images may be performed in accordance with the customer's instructions. The result of processing may be data regarding the remittance of payments. The service may receive the instructions from the customer using a customer portal such as 210 (shown in FIG. 2). Rules or parameters may be selected and specified during customer enrollment step 314. The instructions may involve one or more of dispositions 420 (shown in FIG. 4B) or any other suitable disposition or instruction. The processing of the other images may include providing remittance data to customers data processing systems.

At step 634, the service may attach the deposit receipts to the mail items corresponding to the deposited checks. The mail items may then be filed or refiled in an inventory such as 222 (shown in FIG. 2). Such filing or refiling may involve one or more manual and/or automated processes. The service may file or refile checks that were ineligible for deposit or unable to be deposited. The service may return such checks to the customer. The service may return such checks to the third party. The service may solicit and/or receive an instruction from the customer regarding how to process such checks.

At step 636, the service may return the customer's deposit-only ATM card to a secure ATM card inventory. The service may erase a multi-use ATM card and place the blank card in inventory to be used for the next ATM transaction. Process 600 may end at step 638.

In some instances, the service may be unable to deposit a check. For example, at step 614, the service may determine that the check payee is not the customer. At step 616, the service may determine that the check amount does not match a customer amount entry (such as might be made at step 412 (shown in FIG. 4B). The deposit image ATM may determine that an acceptable image cannot be captured from the check and reject it. If the results of either of step 614 and 616 are so, process 600 may continue at step 640. At step 640, the service may tally adjustments to the customer's expected total deposit amount. Process 600 may continue at step 630. At step 630, the service may notify the customer of deposit completion and of any adjustments of the deposit amount.

After step 640, process 600 may continue at step 642. At step 642, the service may determine whether the check is still eligible for deposit with an adjustment. If the check is still eligible for deposit, process 600 may continue at step 618. If the check is no longer eligible for deposit, process 600 may continue at step 622.

If at step 624 the service identifies a check that was rejected by the image deposit ATM, the check may be returned to the party (i.e., to a third party such as TP (shown in FIG. 2)) that sent the check to the customer. The check may be returned at step 644. The check may be sent on behalf of the customer. The check may be sent with an insert. The insert may include information about any reasons for which the check was not deposited.

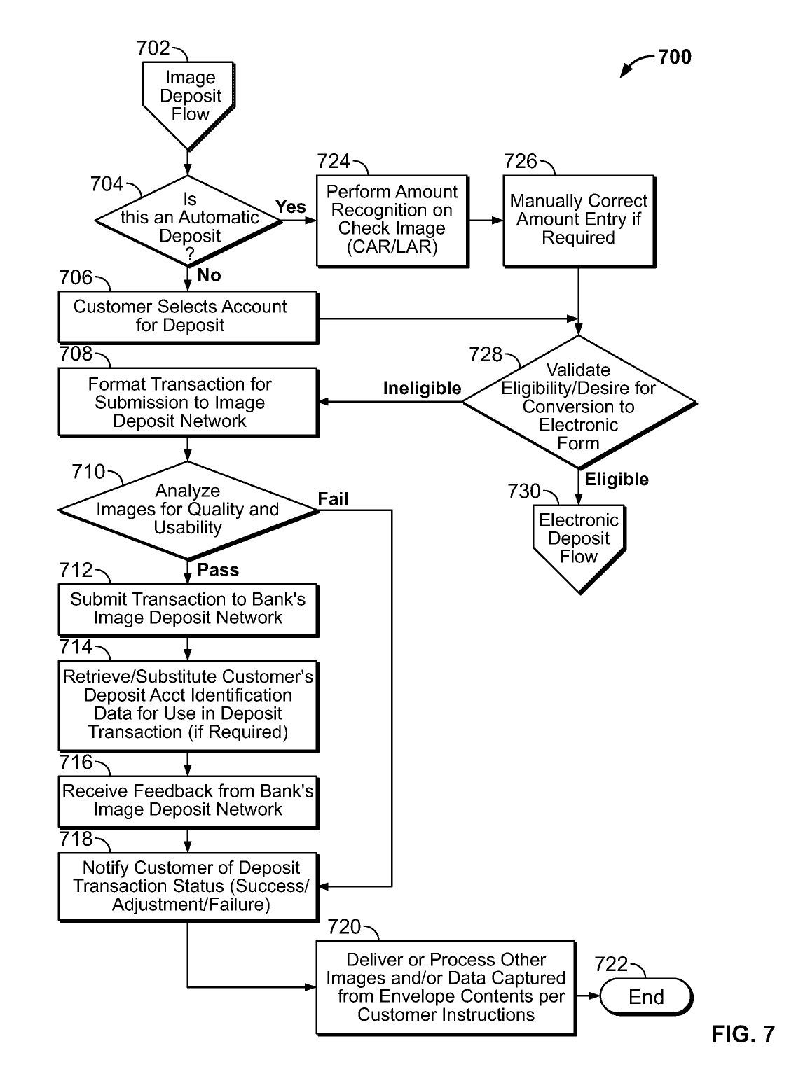

FIG. 7 shows illustrative image deposit process 700. Process 700 may begin at step 702. Step 702 may correspond to step 506 (shown in FIG. 5). Process 700 may continue at step 704. At step 704, the service may determine if the check is to be deposited as an automatic deposit, as may be controlled by customer parameters specified in step 316. If the deposit is not to be an automatic deposit, process 700 may continue at step 706. At step 706, the service may receive from the customer a selection of an account into which the check is to be deposited. The account may be one of numerous accounts identified by the customer in an enrollment step, such as step 312 (shown in FIG. 3), or step 706 may be skipped if the customer has only one eligible deposit account.

Step 706 may be followed by step 728. At step 728, the service may validate eligibility of the check for conversion to electronic form. The service may validate desirability of converting the check to electronic form in accordance with standing instructions from the customer. Criteria may be based on customer preferences, regulatory requirements (e.g., pre-notification of the payor, payor type, etc.) and any other suitable factors.

If the service determines that the check is ineligible for conversion to electronic form, or that it would be undesirable to do so, process 700 may continue at step 708.

If at step 728 the service determines that the check is eligible for conversion to electronic form, and that it is desirable to do so, process 700 may continue at step 730. At step 730, the service may initiate an electronic deposit.

At step 708, the service may format a transaction for submission to an image deposit network. The formatted transaction may be an electronic package for depositing the check. The service may separate check images from other images of mail item contents. For example, a mail item may include a payment coupon. In some embodiments, the payment coupon may be scanned, for example by scanning operations 218 (shown in FIG. 2). The coupon image may be stored for further processing or delivery to the customer. In some embodiments, the coupon may be made available to the customer via an image lock-box. The coupon image may be forwarded with the check image to an image deposit network.

At step 710, the service may analyze the check image for quality and/or usability in the image deposit process. Quality and usability requirements may be based on the quality of the image of the check. If the check meets quality and/or usability requirements at step 710, process 700 may continue at step 712. At step 712, the service may submit the transaction to a depository bank's specified image deposit network or networks. The image deposit network may be a network associated with the depository bank's transaction processing platform such as 240 (shown in FIG. 2). The transaction may be executed using an image exchange network such as 260 (shown in FIG. 2).

At step 714, the service may, if appropriate, provide mutually-understood customer identifiers as substitute for the customer's deposit account identification data for use in the deposit process. The depository bank may insert or substitute bank account numbers for mutually-understood customer identifiers as appropriate. At step 716, the service may receive feedback from the bank's image deposit network. The feedback may confirm the deposit. The feedback may include an error message regarding the deposit.

In some embodiments, steps such as 710, 712, 714 and 716 may be performed on a batch of checks for one customer or for multiple customers. In some of those embodiments, a single daily transmission to the depository bank may be made with commingled deposit transactions for a multitude of customers.

At step 718, the service may notify the customer regarding the status of the deposit transaction. The notification may be performed via a secure web site such as may be provided by postal mail management system 206 (shown in FIG. 2). The notification may be performed by email, text message or any other suitable communication. For example, the status may be: success, amount adjustment or failure. The message may include images of the checks deposited.

At step 720, the service may deliver or process other images and/or data captured from the mail item envelope. The other images and/or data may include views of mail item contents or surfaces, including one or more exterior surfaces. The other images and/or data may be delivered or processed in accordance with instructions that the service may receive from the customer. In some embodiments, the images of the other documents and/or the exterior of the mailing envelope may be made available to the customer via an image message or data stream. The service may process the images prior to delivery to the customer to provide the customer with data present on the images in lieu of the images. In some instances, the service may provide the customer with tabular or XML data which describes the remittances associated with the checks deposited. The service may provide other data forms or analysis known by one familiar in the art as lockbox-like products and services.

If, at step 710, the service determines that the check image quality does not meet quality or usability requirements, process 700 may proceed directly to step 718. In some embodiments, a check that does not meet the requirements may be delivered to the customer for presentment as paper deposits at one of the customer's banks. In some embodiments, checks that do not meet quality and usability requirements may be processed in batch mode. In some embodiments, the service may reprocess the failed checks in order to fine-tune the image capture hardware/software to capture an acceptable image. In some embodiments, the service may discover that the failed checks are not valid for payment by either image or paper processes and may return the checks to the third party.

Process 700 may end at step 722.

If at step 704 the service determines that the deposit is to be made automatically (e.g., in accordance with standing instructions from the customer), process 700 may continue at step 724. At step 724, the service may perform digital amount recognition on the check image. The service may perform courtesy amount recognition (“CAR”) and legal amount recognition (“LAR”) to confirm accuracy of the amount recognition. At step 726, the service may manually enter the check amount, if digital amount recognition is unsuccessful. Alternatively, the customer may be prompted to manually enter the amount if digital amount recognition is unsuccessful.

At step 728, the service may validate eligibility of the check for conversion to electronic form. The service may validate desirability of converting the check to electronic form in accordance with standing instructions from the customer. Criteria may be based on customer preferences, regulatory requirements (e.g., pre-notification of the payor, payor type, etc.) and any other suitable factors. If the service determines that the check is ineligible for conversion to electronic form, or that it would be undesirable to do so, process 700 may continue at step 708. Step 708 and following steps, which may be performed in connection with image deposit transactions, are described above.

If at step 728 the service determines that the check is eligible for conversion to electronic form, and that it is desirable to do so, process 700 may continue at step 730. At step 730, the service may initiate an electronic deposit.

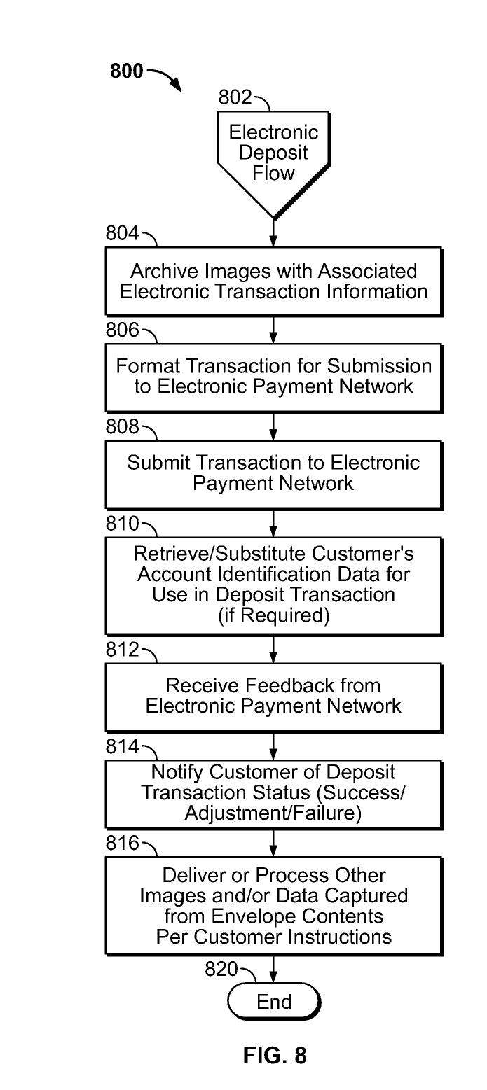

FIG. 8 shows illustrative electronic deposit process 800. In some embodiments, process 800 may be performed in connection with checks that have already been screened for electronic deposit eligibility. For example, process 700 (shown in FIG. 7) may screen check images for such eligibility in step 728. In some embodiments, step 800 may include an eligibility/desirability validation step or steps (not shown). For the purpose of illustration, it will be assumed that the checks processed by process 800 have passed screening for eligibility and/or desirability.

At step 804, the service may archive images associated with electronic transaction information. At step 806, the service may format a transaction for submission to an electronic payment network. The transaction may be formatted and populated with information based on the check image. The transaction may be populated with additional information based on additional images included by the third party with the check, such as a payment coupon. The electronic payment network may be a network such as electronic payment network 270 (shown in FIG. 2). At step 808, the service may submit the transaction to the electronic payment network. In some embodiments, such transactions may be processed in batch mode, say, at the end of a business day. Such submissions may include a multitude of customer transactions commingled in a single batch.

At step 810, the service may retrieve (and/or substitute, as appropriate) the customer's depository bank account identification information with mutually-understood customer identifiers for use in the deposit transaction. The depository bank may subsequently insert or substitute bank account numbers for other mutually-understood customer identifiers as appropriate.

By using step 810, the service may avoid storing the customer's bank account information. The service may link to a secure repository and provide other identifying information for substitution with actual account identification information. In some embodiments, an intermediary network may provide account number substitution.

At step 812, the service may receive feedback from the electronic payment network. The feedback may include status information regarding the electronic deposit transaction. For example, the status may be: success, amount adjustment or failure.

At step 814, the service may notify the customer about the status information. In some embodiments, the notification may be made through the service's secure web site, such as a web site provide in connection with customer portal 210 (shown in FIG. 2). In some embodiments, the notification may be made via email, text messaging or any other suitable notification method.

At step 816, the service may deliver or process other images and/or data captured from the mail item. The other images and/or data may be processed in accordance with standing orders submitted to the service by the customer. The processing of the other images and/or data may be performed in a secure manner to provide an equivalent of the deposit and remittance data flows of lockbox products or services.

Process 800 may end at step 820.

One of ordinary skill in the art will appreciate that numerous exception conditions can and do occur in check and deposit processing. For example, in some instances, check image deposits and/or electronic deposits may contain checks or instructions which are refused and returned by the paying bank due to insufficient funds, stop payment instructions, or other conditions. In such instance, customer and/or service would be notified by paper or electronic messages specifying the reasons for non-payment and return, thus requiring further action by the depositor if payment and settlement is desired. The flows illustrated and described herein could readily support the receipt of messages from the paying bank, whether through postal mail notification or electronic means. For example, process steps 716 and 812 could support the receipt of such non-payment and return messaging. In some embodiments, subsequent reprocessing of returned checks or electronic transactions may be directed by customers or may be governed by standing orders/parameters specified by customers. Reprocessing may be offered by service automatically. In all cases, such reprocessing may be performed in accordance with prevailing industry rules and laws.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for depositing checks in an image mail processing environment have been provided. Persons skilled in the art will appreciate that the present invention can be practiced by other than the described embodiments, which are presented for purposes of illustration rather than of limitation. The present invention is limited only by the claims that follow.

1. A system for electronically depositing a check in a bank account, the system comprising:
an image database configured to store a mail item image on behalf of a user;
a mail item image sewer configured to retrieve the mail item image from the image database for the user;
a customer portal configured to receive an instruction from the user via a secure website, the instruction determining how the mail item image server processes the mail item, the customer portal being in electronic communication with the mail item image server; and
a check information transmitter configured to transmit information corresponding to a check that is included in the mail item.

2. The system of claim 1 further comprising a check detection module that is in electronic communication with the mail item image server.

3. The system of claim 2 wherein the check detection module comprises image analysis logic.

4. The system of claim 2 wherein the check detection module comprises a magnetic ink recognition sensor.

5. The system of claim 1 wherein, when the instruction is an instruction to scan an article from the mail item:
the mail item image sewer is configured to provide an image of the article to the customer portal; and
the customer portal is configured to display the image to the user.

6. The system of claim 5 wherein, when the article is the check, the customer portal is further configured to receive from the user an instruction to deposit the check.

7. The system of claim 1 wherein the check information transmitter is in electronic communication with a bank transaction processing platform.

8. The system of claim 7 wherein the check information transmitter comprises an automated teller machine.

9. The system of claim 1 wherein the check information transmitter is in electronic communication with an image exchange network.

10. The system of claim 1 wherein the check information transmitter is in electronic communication with an electronic payment platform.

11. The system of claim 1 further comprising an electronic mail server in electronic communication with the Internet and the image database; wherein the instruction requests a transfer of the mail item image between the electronic mail server and the image database.

12. The system of claim 1 further comprising an financial data analysis module; wherein the instruction received from the user requests a communication of the information corresponding to the check to the financial data analysis module.

13. A system for electronically depositing a check in a bank account, the system comprising:
a check identification module configured to analyze content of an electronic mail item to determine whether the electronic mail item includes a check; and
a customer portal configured to receive from a customer via a secure website an instruction to deposit the check in a customer bank account.

14. The system of illustrative claim 11 further comprising an ATM for receiving the check.

15. The system of claim 14 wherein the ATM is a deposit-only ATM.

16. The system of claim 15 further comprising an ATM card that authorizes a system agent to initiate only deposit transactions.

17. The system of claim 13 further comprising an image deposit module configured to receive an image of the check and transmit the image to a bank image deposit platform.

18. The system of claim 13 further comprising an electronic transaction conversion module configured to convert the check deposit instruction into an electronic transaction.

19-30. (canceled)
